(19) United States
(12) Patent Application Publication
(10) Pub. No.: US 2009/0091937 A1
(43) Pub. Date: Apr. 9, 2009

(54) LIGHT CONTROL DEVICE HAVING IRREGULAR PRISM SURFACE

(76) Inventor: TIEN-HON CHIANG, Taipei (TW)

Correspondence Address: LEONG C LEI, PMB # 1008, 1867 YGNACIO VALLEY ROAD, WALNUT CREEK, CA, 94598, US

(21) Appl. No.: 11/867,698

(22) Filed: Oct. 5, 2007

(51) Int. Cl. F21V 5/08

(52) U.S. Cl. 362/330

(57) ABSTRACT

The light control device has an array of prism elements, thereby forming a series of interleaving peaks and valleys along a major surface of the light control device, where the surface of the prism elements has bulging bumps and/or the bottoms of the valleys are raised. The bumps are randomly distributed; and the height of the valley bottoms can be randomly distributed, or patterned in accordance with a planar light intensity distribution along a plane. In addition, the light control device can have integrated color correcting and/or diffusing function by dispersing appropriate additives uniformly in the prism elements and/or in the substrate of the light control device. The light control device can have diffusing elements on the other major surface so that the degree of haze/surface roughness is either uniform or patterned.

### BACKGROUND OF THE INVENTION

(a) Technical Field of the Invention

The present invention generally relates to light control devices, and more particularly to a light control device having an array of prism elements with bulging bumps on the surface of the prism elements and/or valleys with raised bottoms.

(b) Description of the Prior Art

Prism sheets are a type of light control devices commonly found in backlight units of liquid crystal displays (LCDs) or LCD TVs. Traditionally, a prism sheet has an array of regular and triangular prism elements aligned in parallel on a major surface of the prism sheet, for directing light passing through the prism sheet into a specific viewing angle. It is also quite well known and common that, as shown in FIG. 1a, two such prism sheets 1 and 2, where the alignments of their prism elements are orthogonal to each other, are incorporated to provide even more enhanced brightness within a narrowed viewing angle. Despite their effectiveness in brightness enhancement, however, the two prism sheets 1 and 2 of FIG. 1a introduce interference and coupling that may result in undesirable optical effects such as moiré pattern and uneven light transmission.

A number of teachings have provided satisfactory solutions. More specifically, U.S. Pat. Nos. 5,919,551 and 5,771,328 teach prism sheets having non-uniform prism elements divided into zones or groups, and the prism elements in different zones or groups form peaks and valleys of different heights and depths. The variable peaks and valleys are able to reduce the optical coupling or the visibility of moiré pattern when one or more prism sheets are used together.

As the prism sheets are most often used together with at least a diffusion sheet in a backlight unit, there are also teachings about integrating the prism sheet and the diffusion sheet into a single light control device. FIGS. 1b and 1c are two possible embodiments of such integration where diffusing elements are coated on a light incidence plane (where light beams enter the light control device) 10 and prism elements are arranged on a light emission plane (where light beams leave the light control device) 20. The difference between FIGS. 1b and 1c lies in that the diffusing elements are uniformly disposed across the light incidence plate 10 in FIG. 1b while the diffusing elements in FIG. 1c, as taught by the U.S. Patent Publication No. 2007/0110386 filed by the present inventor, are “patterned” in accordance with a planar light intensity distribution produced by the light source.

### SUMMARY OF THE INVENTION

The primary purpose of the present invention is to provides a novel light control device that can achieve comparable effect in reducing the optical coupling or the visibility of moiré pattern. The light control device, similar to a conventional one, has an array of prism elements, thereby forming a series of peaks and valleys, along the light emission plane of the light control device. However, unlike the conventional prism sheets having triangular peaks and valleys with well-defined surfaces, the light control device of the present invention has bulging bumps on the surface of the prism elements and/or valleys with raised bottoms.

The height H_{b} (relative to the light emission plane) of the bottoms of the valleys can be randomly distributed across the light emission plane, or the distribution of the height H_{b} can be patterned in accordance with a planar light intensity distribution along a plane. More specifically, assuming that the light control device is perpendicular to the Z-axis of a coordinate system, the height H_{b} for a point (x, y, z₁) along the light emission plane has a functional relationship F with the light intensity e at a point (x, y, z₂) along a plane at the Z location z₂. The surface of the bottoms of the valleys can be flat, slant, or curved.

Also unlike the conventional prism sheets where the prism elements have substantially well-defined surface, the prism elements of the present invention have bumps bulging outward from the surface of the prism elements. The bumps are randomly distributed across the surface of all prism elements. The total area of the bumps should be no more than 25% of the total surface area of all prism elements. The shape of the bumps can be semi-spherical, rod-like, etc.

In addition to the reduction of optical coupling and moiré pattern, the light control device can have integrated color correcting and/or diffusing function by dispersing appropriate additives in at least one of two places: in the prism elements and/or in the substrate of the light control device. The additives include dyes and/or pigments for color absorption, phosphors and/or fluorescent materials for light absorption and reemission, and nano/micro particles for scattering so as to correct the optical characteristics of the incident light beams and to achieve desired optical characteristics from the emitting light beams of the light control device over a range of wavelengths.

The light control device can further have diffusing elements formed on the light incidence plane so that the distribution of the degree of haze/surface roughness across the light incidence plane is either uniform or patterned in accordance with a planar light intensity distribution of a plane. The diffusing elements can also have integrated color correcting and/or diffusing function by dispersing appropriate additives in the diffusing elements. The additives include dyes and/or pigments for color absorption, phosphors and/or fluorescent materials for light absorption and reemission, and nano/micro particles for scattering so as to correct the optical characteristics of the incident light beams.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1a is a schematic sectional view showing two conventional prism sheets with orthogonally aligned prism elements.

FIG. 1b is a schematic sectional view showing a conventional prism sheet having uniformly distributed diffusing elements along the light incidence plane.

FIG. 1c is a schematic sectional view showing a conventional prism sheet having non-uniformly distributed diffusing elements along the light incidence plane.

FIG. 2a is a schematic sectional view showing a light control device according to a first embodiment of the present invention.

FIG. 2b is a schematic sectional view showing how the light control device of FIG. 2a is formed by the application of a mold.

FIG. 2c is a schematic diagram showing an exemplary planar light intensity distribution.

FIG. 2d is a schematic diagram showing a second embodiment of the present invention.

FIG. 2e is a schematic diagram showing a third embodiment of the present invention.

FIG. 2f is a schematic diagram showing a variation of the second embodiment of FIG. 2d.

FIG. 3a is a schematic sectional view showing a light control device according to a fourth embodiment of the present invention where additives are dispersed in the peaks and valleys.

FIG. 3b is a schematic sectional view showing a light control device which is a variation to the light control device of FIG. 3a, where additives are dispersed in the substrate.

FIG. 4a is a schematic sectional view showing a light control device according to a fifth embodiment of the present invention where a uniform distribution of diffusing elements is provided on the light incidence plane.

FIG. 4b is a schematic sectional view showing a light control device according to a sixth embodiment of the present invention where a patterned distribution of diffusing elements is provided on the light incidence plane.

FIG. 4c is a schematic sectional view showing a light control device according to a seventh embodiment of the present invention where additives are dispersed in the diffusing elements.

FIG. 5a is a schematic side view showing an application scenario of a light control device of the present invention with a conventional edge-lit backlight unit.

FIG. 5b is a schematic side view showing another application scenario of a light control device of the present invention which is part of a conventional direct-lit backlight unit.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

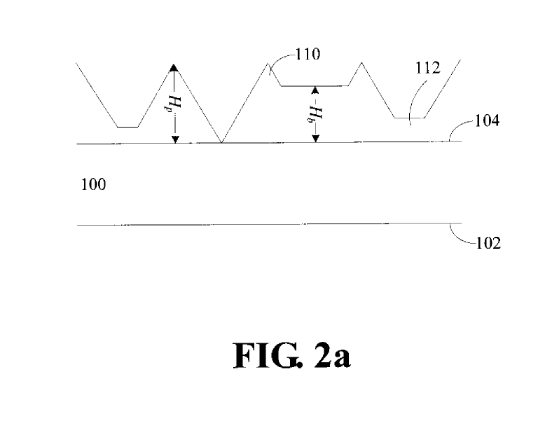

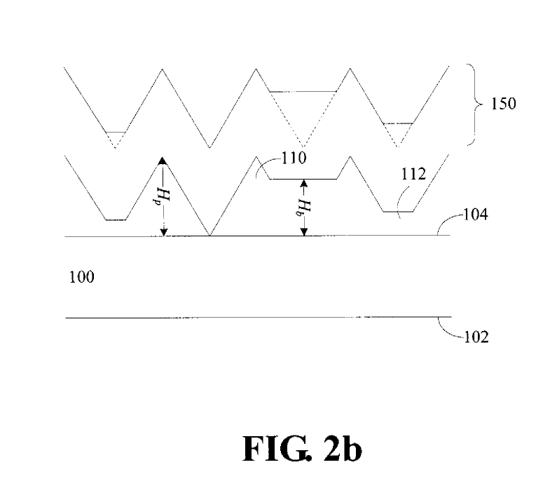

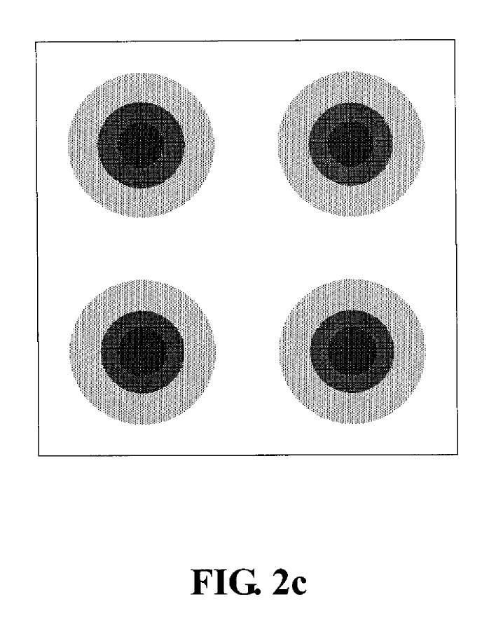

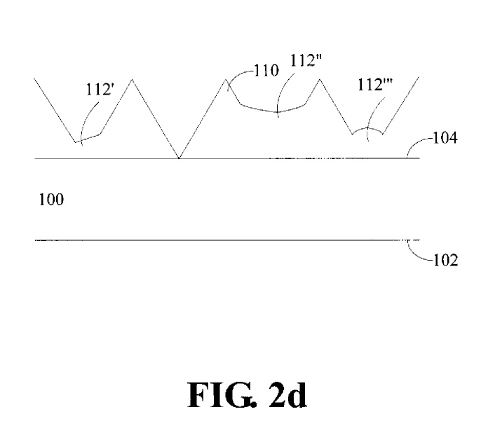

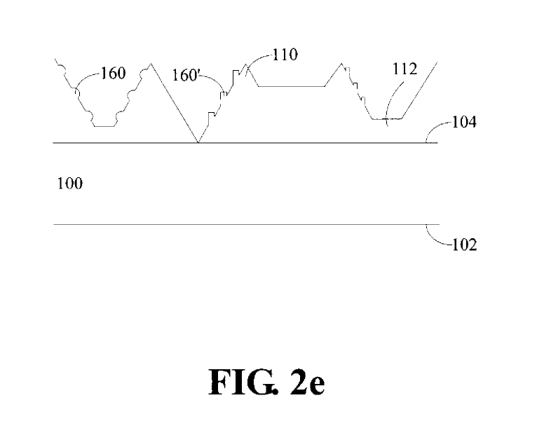

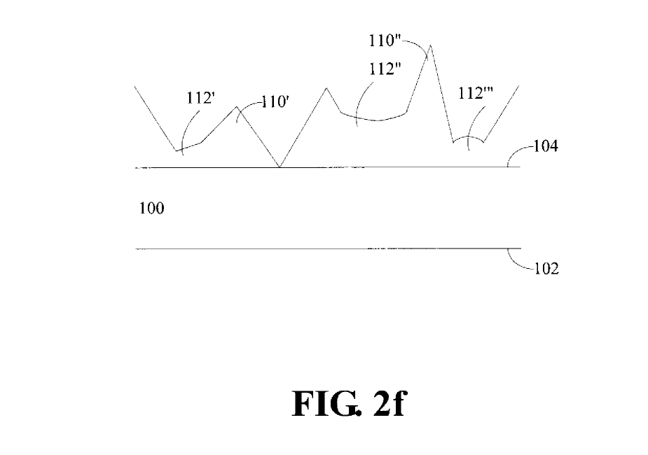

In the present invention, a light control device, such as the diffusion sheet and the prism sheet, manipulates, converts, or transforms the incident light beams in a way into having a desired optical characteristics. According to a first embodiment of the present invention, the light control device, as shown in FIG. 2a, mainly contains a transparent polymer from or plate substrate 100 typically made of a material such as PET, PEN, PMMA, TAC, Polycarbonate, or the like. The light beams emanated from a light source (not shown) consisting of, for example, CCFL tubes or LEDs, enter and exit the light control device via a light incidence plane 102 and a light emission plane 104 or the substrate 100, respectively.

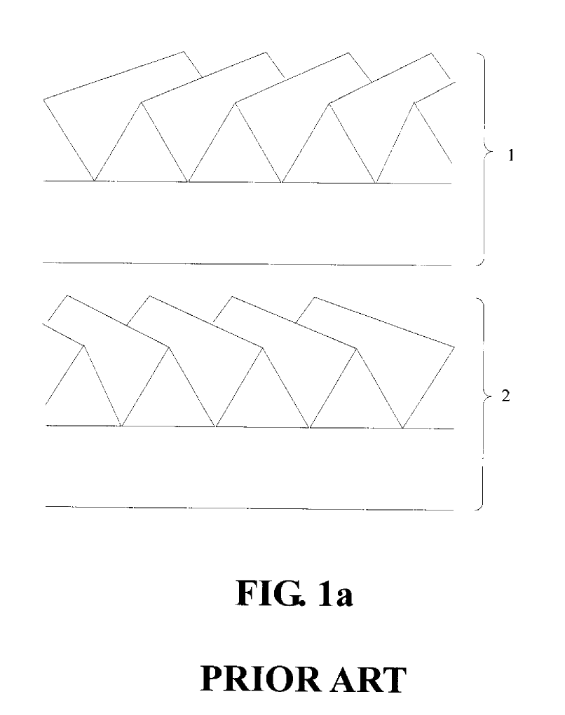

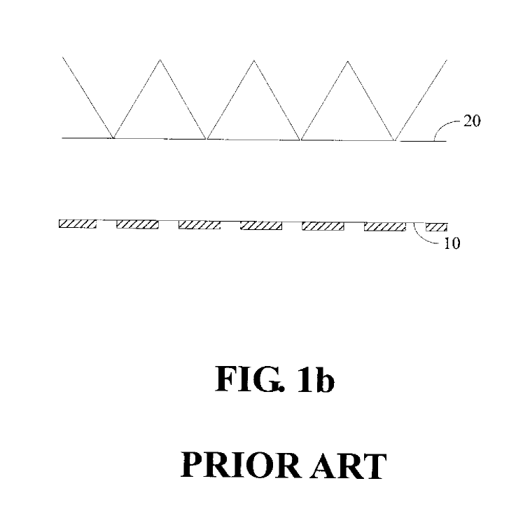

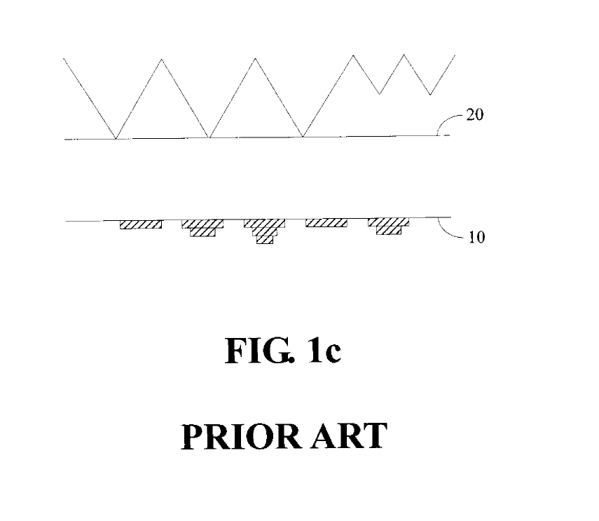

Along the light emission plane 104, an array of interleaving triangular peaks 110 and bottom-raised valleys 112 are provided. The peaks 110 and the valleys 112 are aligned along a direction. The height Hₚ (relative to the light emission plane 104) of the peaks 110 is substantially uniform for all peaks 110 while the height H_{b} (0≦H_{b}≦Hₚ, relative to the light emission plane 104) of the bottoms of the valleys 112 are randomly distributed across the light emission plane 104. In other words, in the present embodiment, there could be some valleys 112 whose bottoms has H_{b} equal to zero (i.e., the valleys 112 have pointed bottoms) and there could be some valleys 112 whose bottoms has H_{b} close to H_{b} (i.e., the valleys 112 are almost tilled to the top). As can be seen from FIG. 2a, the present embodiment provides randomly variable peaks and valleys similar to the prior arts (such as FIG. 1b). The peaks and valleys 110 and 112 are typically in the micrometer (i.e., 1˜10³ μm) or sub-micrometer (i.e., 1˜10⁻² μm) dimension. Other than that, the present invention does not impose specific requirements on the geometric properties of the peaks and valleys 110 and 112 such as their height, vertex angle, and bottom width.

The formation of the triangular peaks 110 and the bottom-raised valleys 112 is rather straight forward. For example, as shown in FIG. 2b, a mold 150 for regular prism elements is prepared by machinery, lithographic, or MEMS methods. Then, the pointed ends (i.e., those shown in dashed lines) of the molds 200 are randomly removed by laser trimming, chemical etching, or other appropriate means. Further; UV (ultra violet) or thermal curable resins having an appropriate refractive index, preferably in the range of 1.55˜1.75, are coated on the light emission plane 104 of the substrate 100 using flexography or micro gravure methods. Finally, the peaks and valleys 110 and 112 are formed by the embossment of the mold 200 on the coated resins and, subsequently, solidified through UV or thermal curing.

In the present embodiment, the height H_{b} of the bottom-raised valleys 112 is randomly distributed across the light emission plane 104. Such a random distribution assumes that the light source provides truly planar light. In real life, this is seldom the case and more often that the light source is not uniform. Therefore, in an alternative embodiment, the height H_{b} of the bottom-raised valleys 112 can be “patterned” in accordance with a planar light intensity distribution along a plane. To give an example of the planar light intensity distribution, assuming that the light source contains four light emitting diodes, a planar light intensity distribution as illustrated in FIG. 2c can be perceived along a plane in front of the light source and perpendicular to the light beams emanated from the light source. Please note that, in the drawing, darker points represent stronger light intensities and similar planar light intensity distribution can be produced by the light source along the light incidence plane and the light emission plane of the light control device.

More specifically, assuming that the light control device is perpendicular to the Z-axis of a coordinate system and the light source is positioned on the Z-axis as well, the height H_{b} for a point (x, y, z₁) along the light emission plane 104 at the Z location z₁ has a functional relationship F with the light intensity e at a point (x, y, z₂) along a plane at the Z location z₂. That is, H_{b}(x, y, z₁)=F(e(x, y, z₂)), where e(x, y) is referred to as the planar intensity distribution along the plane at the Z location z₂. If z₂=z₁, the height H_{b} is said to be “patterned” in accordance with the planar light intensity distribution along the light emission plane 104; if z₂ is where the light incidence plane 102 is located, the height H_{b} is said to be “patterned” in accordance with the planar light intensity distribution along the light incidence plane 102; and if z₂ is where the light source is located, the height H_{b} is said to be “patterned” in accordance with the planar light intensity distribution of the light source. The function F is not limited to a specific function. Some examples are as follows: H_{b}(x, y, z₁)=F(e(x, y, z₂))=C×e(x, y, z₂) (i.e., a linear function); or H_{b}(x, y, z₁)=F(e(x, y, z₂)=C (i.e., a constant function), where C is a constant in both examples. For the former, the height H_{b} would be higher at points perceiving stronger light while, for the latter, the height H_{b} would be constant across the light emission plane 104.

FIG. 2d is a schematic diagram showing a second embodiment of the present invention. As can be imagined, depending on how the pointed ends of the prism elements of the mold 150 (shown in FIG. 2b) is trimmed or etched, the bottoms of the valley 112 can be flat (i.e., substantially parallel to the light emission plane 104), slant (i.e., such as the bottom of the valley 112′ having a less-than-90-degree angle against the light emission plane 104), or curved (such as the bottom of the valley 112″ that is arced towards the light emission plane 104 or the bottom of the valley 112″ that is arced away from the light emission plane 104). The height H_{b} for the slant or curved bottom of the valleys 112′ or 112″ or 112′″ can be defined using the point closest to or farthest from the light emission plane 104, or at the center of the bottom. For simplicity, the subsequent description of the other embodiments of the present invention mainly uses flat bottom-raised valleys as example.

A similar approach in achieving irregularity in the prism elements can be derived from the foregoing description. In addition to trimming the pointed ends of the prism elements of the mold 150, the surface of the prism elements of the mold 150 can be further processed by sand paper or laser drilling or other similar means to form holes along the surface of the mold 150. As shown in FIG. 2e, after the embossment of the mold 150, the surface of the prism elements according to a third embodiment of the present invention can have a number of bumps. Depending on the shape and depth of the holes formed on the mold 150, the bumps can be semi-spherical (such as the bumps 160) or rod-like (such as the bumps 160′). The bumps can have other shape but they are always bulging outward from the surface of the prism elements and the dimension of the bumps is typically an order of magnitude smaller than that of the prism elements. Please note that the bumps can also be formed on the bottom of the valleys 112 (even though it is not shown in FIG. 2e) and, further more, the formation of the bumps and the bottom-raised valleys can be implemented together as shown in FIG. 2e, or they can be implemented separately in different embodiments.

The bumps 160 and 160′ are formed such that they are randomly distributed across the surface of the peaks and valleys. The total area covered by the bumps 160 and 160′ is preferably not more than 25% of the total surface area of the peaks and valleys. In the following, for simplicity, the subsequent description of the other embodiments of the present invention mainly uses flat bottom-raised valleys as example, but the principles apply to the embodiments with bumpy prism elements as well.

In the foregoing description, it has assumed that the heights and the vertex angles of the peaks are substantially uniform for all peaks. However, the principle of the present invention is not necessarily limited in this manner. As can be imagined, by an appropriate mold, the peaks may have different vertex angles and may have different heights. FIG. 2f is a variation of the embodiment shown in FIG. 2d. As illustrated, the peak 110′ has a smaller height and a larger vertex angle compared to the peak 110″. In other words, the present invention only requires that the light control device has a series of peaks and valleys aligned in a direction; whether the peaks have a regular and uniform geometric property is of no concern to the present invention.

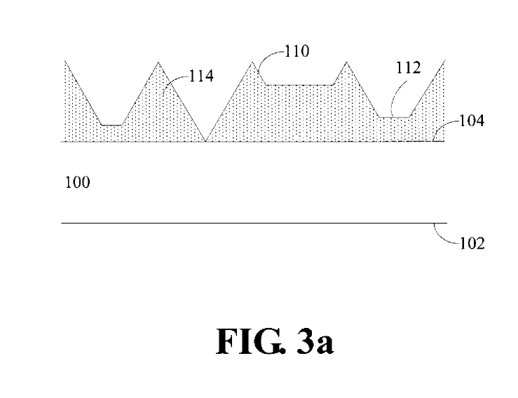

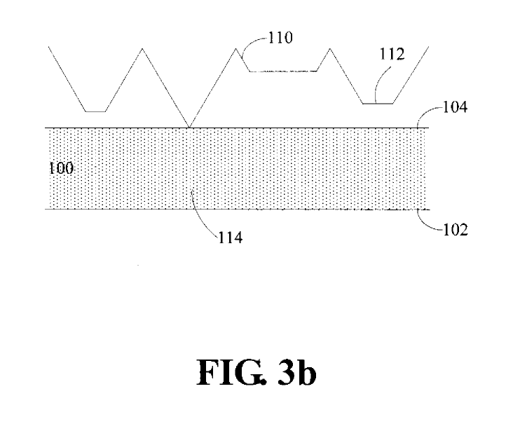

FIG. 3a is a schematic diagram showing a fourth embodiment of the present invention where color correction and/or diffusing function is integrated in the light control device. As illustrated, additives 114 of appropriate dyes and/or pigments for color absorption, phosphors and/or fluorescent materials for light absorption and reemission, or nano/micro particles for scattering are dispersed, usually uniformly, in the UV or thermal curable resins forming the peaks 110 and valleys 112 before the resins are coated and embossed on the light emission plane 104. The purpose of having these additives 114 is to correct the spectral characteristics of the incident light beams to the light control device so as to achieve desired spectral characteristics from the emitting light beams of the light control device over a range of wavelengths. This color correction function is useful when the light source contains an assortment of red-, green-, and blue-light LEDs delivering a less than satisfactory color mix, or when the light source contains white-light LEDs delivering white light with a particularly strong or weak color component(s) (e.g., bluish white light).

More specifically, appropriate dyes or pigments can absorb excessive, for example, red and green lights. It is also quite well known that phosphors such as (1) Tris (dibenzoylmethane) Mono (phenanthroline) Europium Complex, or (2) Acetylacetonate Irdium Complex could absorb excessive UV and/or blue light and reemit red light. Similarly, phosphors such as (1) Coumarin Molecules, or (2) Tris (8-hydroxyquinolinolato) Metal System could absorb excessive UV and/or blue light and reemit green light. Many such pigments, dyes, nano/micro particles, phosphors, and/or fluorescent materials have already been disclosed in the related arts and no further detail is provided here for simplicity sake. In short, the dyes, pigments, nano/micro particles, phosphors, and/or fluorescent materials change the spectral distribution of the incident light over a range of wavelengths to match a desired spectral distribution so that a superior color mixing could be achieved by the light control device. As to the nano/micro particles, for example, excessive red and green lights can be suppressed by scattering with appropriate nano/micro particles. On the other hand, the light beams can also be scattered to various directions by the nano/micro particles so that a diffusing function is also integrated into the light control device. As shown in FIG. 3b, the additives 114 may be dispersed uniformly in the substrate 100, instead of in the prism elements, to achieve the color correction and/or diffusing function described above. In some alternative embodiments, the additives 114 are dispersed uniformly both in the prism elements and the substrate 100.

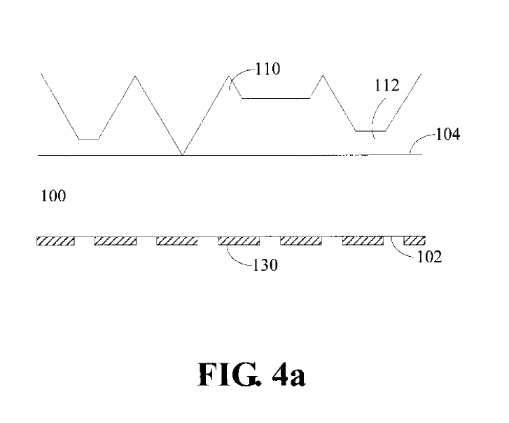

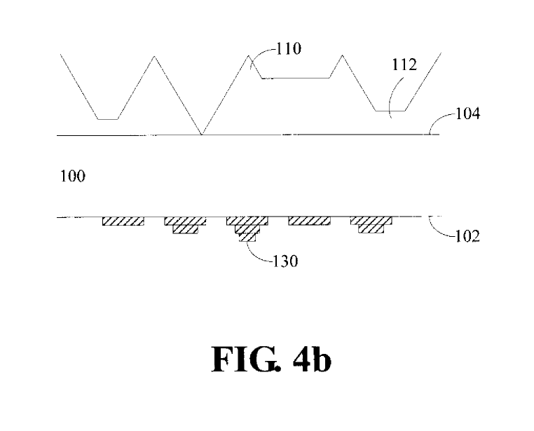

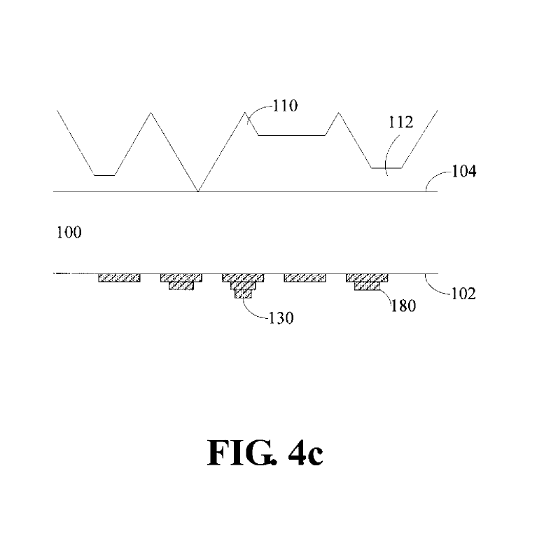

FIG. 4a is a schematic sectional view showing a fifth embodiment of the present invention where diffusing elements 130 are formed on the light incidence plane 102 to achieve a uniform distribution of degree of haze or surface roughness. The diffusing elements 130 are made of UV and/or thermal curable resins which contain nano/micro particles (not shown) to scatter the light. The resins are then coated on the light incidence plane 102 of the substrate 100 using flat plate or roll to roll printing to achieve a uniform degree of haze or surface roughness along the light incidence plane 102. Similarly, the diffusing elements 130 can also be formed so that the degree of haze or surface roughness is patterned in accordance with the planar light intensity distribution of the light incidence plane 102 or of the light source, as in a sixth embodiment of the present invention shown in FIG. 4b.

Again, more specifically, assuming that the light control device is perpendicular to the Z-axis of a coordinate system and the light source is positioned on the Z-axis as well, the degree of haze or surface roughness for a point (x, y, z₅) along the light incidence plane 102 at the Z location of z₅ has a functional relationship F′ with the light intensity at a point (x, y, z₆) along a plane at the Z location z₆. If z₅=z₆, the degree of haze or surface roughness is said to be patterned in accordance with the planar light intensity distribution along the light incidence plane 102; and if z₆ is where the light source is located, the degree of haze or surface roughness is said to be patterned in accordance with the planar light intensity distribution of the light source. The function F′ is not limited to a specific function as described earlier.

To achieve the patterned distribution of the degree of haze or surface roughness, appropriate masks are derived from an analysis of the light intensity distribution of the light incidence plane 102 or the light source. The masks are then applied sequentially in the aforementioned flat plate or roll to roll printing to obtain a non-uniform distribution of the diffusing elements 130 (and, therefore, a non-uniform distribution of the degree of haze or surface roughness).

FIG. 4c is a schematic sectional view showing a seventh embodiment of the present invention. As illustrated, similar color correction function is integrated in the diffusing elements 130 by incorporating additives 180 in the diffusing elements 130. Again, the additives 180 including appropriate dyes and/or pigments for color absorption, and phosphors and/or fluorescent materials for light absorption and reemission are dispersed, usually uniformly, in the UV or thermal curable resins forming the diffusing elements 130.

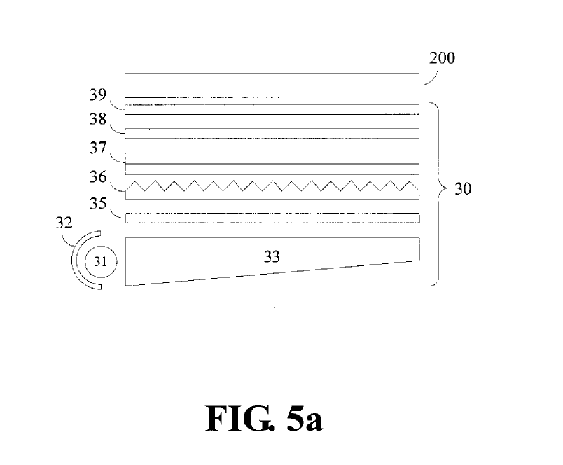

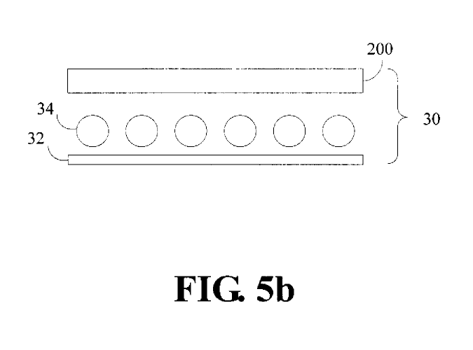

Some final notes to the present invention are as follows. First, so far the present invention has been specified that the peaks and valleys 110 and 112 are always positioned along the light emission plane 104. However, in some special applications, the light control device is actually flipped up-side-down so that the peaks and valleys 110 and 112, instead of facing away from, face towards the light source. That is, the peaks and valleys 110 and 112 are actually positioned along the light incidence plane 102. Secondly, the term “light source” is used abstractly in the present specification. For example, FIG. 5a is a schematic side view showing an application scenario of the light control device 200 of the present invention with a conventional edge-lit backlight unit 30. As shown in FIG. 5a, the entire backlight unit 30 is considered a “light source” where light beams emitted from a CCFL tube 31 is directed into a side of a light guide plate 33 by a reflector 32 and then redirected to the light control device 200. The backlight unit 30 further contains a diffusion sheet 35 for scattering the light from the light guide plate 33, two prism sheets 36 and 37 whose respective prism elements are aligned orthogonally for focusing the scattered light from the diffusion sheet 35 into substantially parallel light beams, a polarization or anti-reflection film 38, and another diffusion sheet 39 to achieve further intensity uniformity of the light beams. As another example, FIG. 5b is a schematic side view showing another application scenario of the light control device 200 of the present invention. As shown in FIG. 5b, multiple LEDs 34 of the backlight unit 30 are arranged in front of the reflector 32 so as to direct light all towards the light control device 200. In this scenario, the light control device 200 is actually a part of the direct-lit backlight unit 30 where, to the light control device 200, the light source is the combination of LEDs 34 and the reflector 32.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A light control device positioned in the path of light from a light source, comprising:
a transparent substrate having a first major surface and a second major surface opposing to said first major surface, wherein the light beams from said light source entering said transparent substrate through one of said first and said second major surfaces and exiting said transparent substrate through the other major surface; and
a plurality of transparent peaks and bottom-raised valleys aligned in a direction along said first major surface, wherein the height of the bottoms of said raised valleys relative to said first major surface has a planar distribution across said first major surface.

2. The light control device according to claim 1, further comprising a plurality of diffusing elements on said second major surface, delivering a planar distribution of the degree of haze or surface roughness across said second major surface.

3. The light control device according to claim 2, wherein said planar distribution of the degree of haze or surface roughness has a functional relationship with a planar light intensity distribution of one of said light source and said second major surface.

4. The light control device according to claim 2, wherein said planar distribution of the degree of haze or surface roughness is substantially uniform.

5. The light control device according to claim 2, wherein said diffusing elements are made of a UV or thermal curable resin containing a plurality of nano/micro particles.

6. The light control device according to claim 2, wherein said diffusing elements has a plurality of additives embedded; and said additives are at least one of the following: dyes, pigments, phosphors, fluorescent materials.

7. The light control device according to claim 6, wherein said additives are substantially uniformly distributed among said peaks and valleys.

8. The light control device according to claim 1, wherein said peaks and valleys are made of a UV or thermal curable resin.

9. The light control device according to claim 1, wherein a plurality of additives are embedded in at least one of said substrate and said peaks and valleys; and said additives are at least one of the following: dyes, pigments, nano/micro particles, phosphors, fluorescent materials.

10. The light control device according to claim 9, wherein said additives are substantially uniformly distributed.

11. The light control device according to claim 1, wherein said planar distribution of the height of the bottoms of said bottom-raised valleys is substantially uniform.

12. The light control device according to claim 1, wherein said planar distribution of the height of the bottoms of said bottom-raised valleys has a functional relationship with a planar light intensity distribution of one of said light source, said second major surface, and said first major surface.

13. The light control device according to claim 1, wherein the bottom of at least a valley is one of the following: substantially flat, slant against said first major surface, curved towards said first major surface, and curved away from said first major surface.

14. The light control device according to claim 1, wherein at least two peaks of said light control device have different vertex angles.

15. A light control device positioned in the path of light from a light source, comprising:
a transparent substrate having a first major surface and a second major surface opposing to said first major surface, wherein the light beams from said light source entering said transparent substrate through one of said first and said second major surfaces and exiting said transparent substrate through the other major surface; and
a plurality of transparent peaks and valleys aligned in a direction along said first major surface, wherein a plurality of bumps are randomly distributed across the surface of said peaks and valleys.

16. The light control device according to claim 15, further comprising a plurality of diffusing elements on said second major surface, delivering a planar distribution of the degree of haze or surface roughness across said second major surface.

17. The light control device according to claim 16, wherein said planar distribution of the degree of haze or surface roughness has a functional relationship with a planar light intensity distribution of one of said light source and said second major surface.

18. The light control device according to claim 16, wherein said planar distribution of the degree of haze or surface roughness is substantially uniform.

19. The light control device according to claim 16, wherein said diffusing elements are made of a UV or thermal curable resin containing a plurality of nano/micro particles.

20. The light control device according to claim 16, wherein said diffusing elements has a plurality of additives embedded; and said additives are at least one of the following: dyes, pigments, phosphors, fluorescent materials.

21. The light control device according to claim 20, wherein said additives are substantially uniformly distributed among said peaks and valleys.

22. The light control device according to claim 15, wherein said peaks and valleys are made of a UV or thermal curable resin.

23. The light control device according to claim 15, wherein a plurality of additives are embedded in at least one of said substrate and said peaks and valleys; and said additives are at least one of the following: dyes, pigments, nano/micro particles, phosphors, fluorescent materials.

24. The light control device according to claim 23, wherein said additives are substantially uniformly distributed.

25. The light control device according to claim 15, wherein the total area covered by said bumps are no more than 25% of the total surface area of said peaks and valleys.

26. The light control device according to claim 15, wherein the shape of at least a bump is one of the following: substantially semi-spherical and rod-like.

27. The light control device according to claim 15, wherein at least two peaks of said light control device have different vertex angles.
